(19) United States
(12) Patent Application Publication
(10) Pub. No.: US 2007/0200666 A1
(43) Pub. Date: Aug. 30, 2007

(54) Door lock capable of local and remote actuation for synchronized operation

(76) Inventor: James Marshall Howard, Hillsboro, OR (US)

Correspondence Address: JAMES M. HOWARD, 6039 CLAIRMONT CT, LAKE OSWEGO, OR, 97035, US

(21) Appl. No.: 11/353,479

(22) Filed: Feb. 13, 2006

(51) Int. Cl. G05B 19/00

(52) U.S. Cl. 340/5.62; 340/5.7; 340/5.5

(57) ABSTRACT

A door lock coupled to a communications device, wherein the door lock is capable of both local and remote actuation enabling the actuation of multiple door locks to be synchronized.

### BACKGROUND OF THE INVENTION

1. Field of the Invention

The present invention relates to the field of door locks, and more particularly to a door lock that can be synchronized or coordinated with another to lock and unlock in concert.

2. Discussion of Related Art

For centuries, architectural designs have employed floor plans having a plurality of entryways accessing a common interior space from neighboring interior spaces. Such a design is a highly efficient use of the interior square footage because it eliminates hallways that must otherwise be employed if a common space is provided with only one access point. However, difficulties with the design arise when activities requiring privacy are conducted in the common space. Such is the case for a bathroom designed to have a plurality of entryways. For example, bathroom floor plans similar to that shown in FIG. 1 are typical in many residential buildings. In such a floor plan, both room 10 and room 30 are connected to the common bathroom 20 via a separate entryway between each room. Privacy is maintained in the shared bathroom 20 by “gating” both entryways with doors 15 and 25 having locks 17 and 26, respectively. Locks 17 and 26 are individually actuated from the interior of the bathroom 20 upon closing the doors 15 and 25. Variations on the floor plan shown in FIG. 1 are so popular in Western architecture they are commonly referred to as “Jack and Jill” bathrooms.

While providing a plurality of entryways to the common space is an efficient use of interior space, the efficiency has heretofore frequently come at the expense of occupant privacy and aggravation. As shown in FIG. 1, spaces with a plurality of gated entryways require a plurality of locks 17 and 26, both of which must be repeatedly actuated, once to secure common space 20 during occupation of common space 20 and then once again to unsecure common space 20 after use. Generally, having more gated entryways than the one physically accessed by the user can cause different failures. First, a person occupying the common space may fail to lock each of the plurality of gated entryways upon entry, thereby failing to completely secure the common space Second, an occupant of a first space may prevent the occupant of a second space from accessing the common space by failing to unlock each of the plurality of gated entryways prior to exiting the common space. For example, referring to FIG. 1, occupant of space 10 can accidentally prevent the occupant of space 30 from accessing the common space 20 by failing to unlock gated entryway 25 upon exiting common space 20 through gated entryway 15.

Finally, when the gated common space is adjacent to another private space, such as when a common bathroom adjoins a private bedroom, a third type of failure can occur. Typically, the gated entryway between the common or shared room and the private room is secured only from the interior side of the shared room so as to only gate the entry into the shared room. However, entry into the private room from the common room is not usually gated because if all such entryways of the shared room were so gated, an occupant of the shared room could be inadvertently imprisoned within the common bathroom. Therefore, because entry from the common space into the adjacent private space is not gated, the occupants of the private space adjacent to the gated common space suffer a loss of privacy. As an example, referring to FIG. 1, a person entering common space 20 from space 10 can actuate lock 26 and prevent entry into common space 20 from space 30. However, there is no means for the occupant of space 30 to prevent an unwanted entry from the common space 20 into space 30.

Thus, while a common space having multiple entries is an elegant and efficient design architecturally, it is nearly unlivable if the common space is routinely utilized for any activities requiring privacy. For these reasons the “Jack and Jill” residential bathroom design has lost considerable consumer appeal over recent years. Therefore, there exists a need to achieve the advantages of a common space having multiple gated entries without suffering the drawbacks heretofore inherent in such a design.

### BRIEF DESCRIPTION OF THE DRAWINGS

FIG. 1 is an illustration of a floor plan view of a conventional Jack and Jill bathroom with adjacent rooms.

FIG. 2 is an illustration of a first cross-sectional view of a door handle assembly in accordance with an embodiment of the present invention.

FIG. 3 is an illustration of a second cross-sectional view of a door handle assembly in accordance with an embodiment of the present invention.

FIG. 4 is an illustration of a floor plan view of a Jack and Jill bathroom with adjacent rooms in accordance with an embodiment of the present invention.

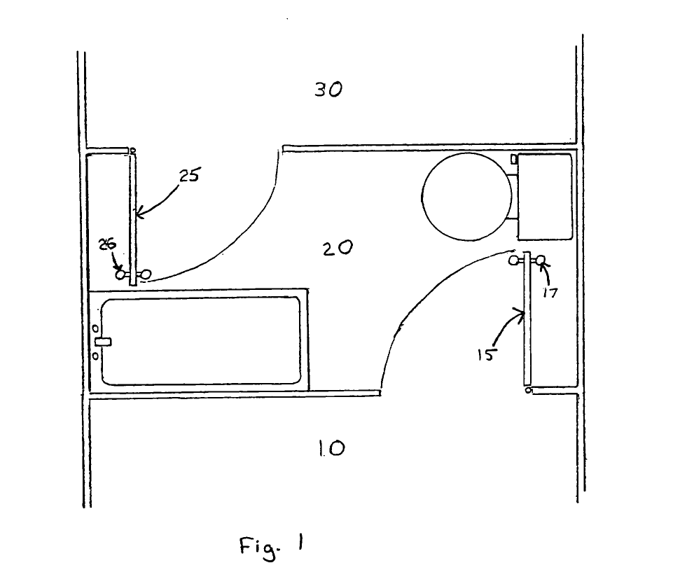

### DETAILED DESCRIPTION OF THE PRESENT INVENTION

A door locking apparatus and method of operation are described herein. In the following description, numerous specific details are set forth, such as specific materials, dimensions and relative locations, etc. to provide a thorough understanding of the present invention. In other instances, well-known subsystems utilized by the present invention have not been described in particular detail to avoid unnecessarily obscuring the present invention.

Most generally, embodiments of the present invention include door locks capable of increasing privacy between shared or common rooms and neighboring private rooms through the use of communications devices coupled to a door lock to synchronize the actuation of multiple locks. Other embodiments of the present invention include door locking devices capable of increasing privacy between shared or common rooms and neighboring private rooms by providing a door lock that can be actuated (locked and unlocked) from various sources originating from either side of a door. In such embodiments, a microcontroller applies an algorithm to the various actuation commands received to dictate engagement and disengagement of the door lock.

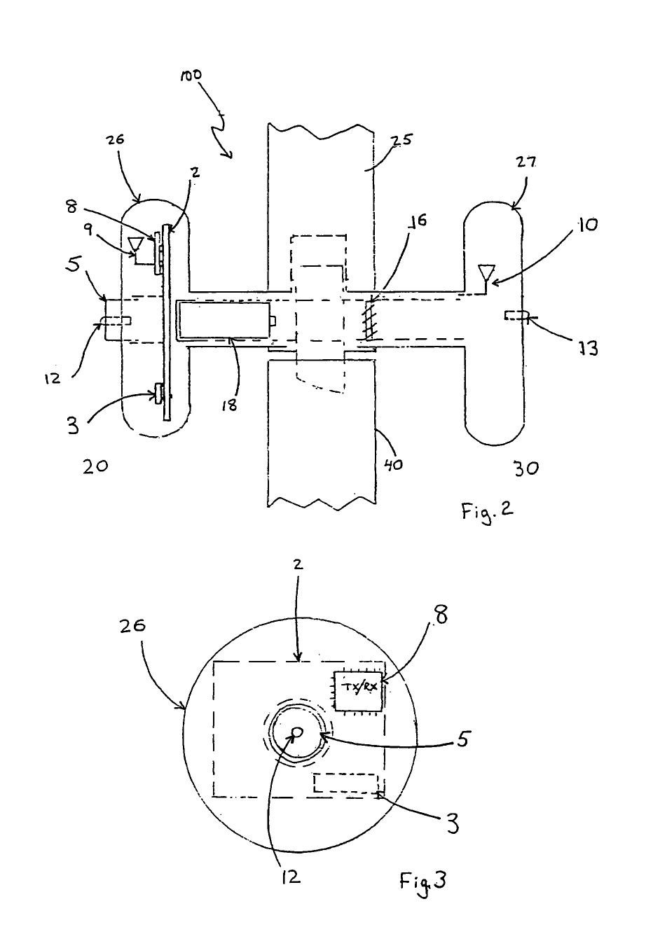

FIG. 2 shows a first embodiment of the present invention. Referring to FIG. 2, assembly 100 is typically fitted to door 25 and used to secure door 25 to wall 40 thereby gating the entryway between room 20 and room 30. Assembly 100 comprises door handle 26 on a first side and handle 27 on a second side. The first side of assembly 100 extends from door 25 into room 20 and the second side of assembly 100 extends from door 25 into room 30. Assembly 100 further comprises a door lock 16 coupled to a communications device 8. Door lock 16 may be any common locking mechanism that can be electronically engaged (locked) and electronically disengaged (unlocked) by controller 3. In a certain embodiment, door lock 16 comprises a solenoid. In some embodiments more than one door lock is incorporated to provide independent door locks for each of door handles 26 and 27.

Controller 3 processes lock actuation commands received locally from local input device 5 on the first handle 26, as wells as lock actuation commands received remotely by a coupled communications device 8. In a particular embodiment, controller 3 is a microcontroller comprised of a logic circuit portion, a driver portion, and a memory portion. In various embodiments controller 3 is an IC which may or may not be further integrated with the communications device 8.

Local input device 5 may be any ordinary user operable control device, such as a mechanical or electrical switch or similar means. In the specific embodiment shown in FIG. 2, local input device 5 is a pressure sensitive mechanical switch. In other embodiments, local input device 5 is a capacitive or inductive switch. In certain embodiments, depressing local input device 5 causes controller 3 to engage door lock 16 and turning handle 26 releases local input device 5 and causes controller 3 to disengage door lock 16. Local input device 5 is proximate to door handle 26 enabling a user manipulating door handle 26 to actuate local input device 5 and cause door lock 16 to engage or disengage. In the specific embodiment shown in FIG. 2, local input device 5 is incorporated into the door handle 26, but in other embodiments local input device 5 may be incorporated into door 25 or wall 40. In some embodiments a local input device 5 may be further provided proximate to the door handle 27, thereby providing a local input device on both sides of door 25.

In various embodiments, coupled communications device 8 both receives instructions from remote sources and transmits instructions to remote destinations. In a particular embodiment, local actuation of the door lock 16 causes the coupled communications device 8 to send information. Local actuation of the door lock entails a user engaging or disengaging the door lock via an input device positioned within arm's reach of the door handle assembly securing the entryway physically accessed. In certain embodiments, because the input device is “local,” it may be hard wired to the door lock. In another specific embodiment of the present invention, local actuation of the door lock causes the coupled communications device to transmit an instruction for actuating a remote lock. In a further embodiment, local actuation of the door lock causes the coupled communications device to transmit an instruction for actuating a remote lock in substantial unison with the locally actuated lock. In yet another embodiment, local actuation of the door lock causes the coupled communications device to transmit a status flag identifying the lock position as engaged (door locked) or disengaged (door unlocked). In still other particular embodiments, communications device 8 relays messages from a remote source to a remote destination.

Generally, “lock” and “unlock” commands that are addressed to the communications device 8 from remote sources are input to a controller processing an algorithm to determine how door lock 16 is actuated. In an embodiment of the present invention, receipt of a “lock” command addressed to communications device 8 ultimately causes the door lock 16 to engage or lock. In another embodiment, receipt of an “unlock” command addressed to communications device 8 ultimately causes the door lock 16 to disengage or unlock. In a further embodiment, “lock” and “unlock” commands from local sources cause the communications device to transmit information, instructions, or commands to predetermined remote destinations. In one embodiment, referring to FIG. 2, input to local input device 5 causes the communications device 8 to transmit a “lock” command to predetermined remote destinations. Similarly, locally disengaging door lock 16 in various ways, such as turning handle 26 or 27, causes the communications device 8 to transmit an “unlock” command to predetermined remote destinations.

In the embodiment shown in FIG. 2, communications device 8 is a wireless transceiver coupled to antennae 9 and 10. As shown in FIG. 2, antenna 9 is incorporated into door handle 26 and antenna 10 is incorporated into door handle 27. Multiple antennas are useful to improve signal to noise ratios and to ensure that door 25 or wall 40 does not block communication to and from wireless transceiver 8, but in various other embodiments only a single antenna is coupled to wireless transceiver 8. In still other embodiments a plurality of communications devices are coupled to the door lock 16. In particular embodiments of the present invention, wireless transceiver 8 is an RF transceiver complying with the IEEE 802.15.4 communication protocol, or what is commonly referred to as ZigBee. Such embodiments have the advantage of very low power consumption and a transmission range sufficient for most applications. In certain other embodiments, wireless transceiver 8 complies with the various IEEE 802.11x wireless communication standards in common use. Such embodiments are better suited to applications requiring a greater range than ZigBee provides. It is also within the scope of the present invention for communications device 8 to be connected to a WAN such as the Internet and send and receive commands to and from virtually anywhere in the world. In certain other embodiments of the present invention, wireless transceiver 8 utilizes infrared or other optical communications. In still other embodiments communications device 8 is a wired transceiver having wired connections to remote sources and/or remote destinations.

Particular embodiments of the present invention further comprise a visual indicator capable of displaying the status of door lock 16. The visual appearance of the visual indicator changes when door lock 16 changes between an engaged and disengaged state. The visual indicator is useful for displaying to a user at a distance feedback on the operation of the door lock 16. Such visual feedback provides a means for a user to quickly check the level of security being provided by door lock 16. The visual feedback can also provide information about the availability of the room on the other side of the entryway. In the embodiment shown in FIG. 2, a first visual indicator 12 is incorporated into door handle 26 and second visual indicator 13 is incorporated into door handle 27. Visual indicator 12 provides feedback information to a user in room 20 while visual indicator 13 provides feedback information to a user in room 30. In a particular embodiment, visual indicator 13 provides a visual indication of whether room 30 can be entered from room 20 and whether room 20 can be entered from room 30. In certain embodiments, the visual indicator is comprised of at least onelight emitting diode (LED). In another certain embodiment the visual indicator is a liquid crystal display (LCD). Various other embodiments utilized other commonly known information displays, such as colored flags or labels.

Particular embodiments of the present invention further comprise a battery power source. A battery power source enables the present invention to be a self-contained unit suitable for retrofitting to existing structures without the need for expensive rewiring of door 25 or wall 40. Various commonly known batteries may be used as power sources depending on the voltage and current requirements of the communications device, controller, and door lock for a particular application. For example, an 800 mah battery would be sufficient to power the particular embodiments utilizing a ZigBee compliant transceiver for a year or more. The current drain on the battery would further depend on the size and design of the door lock. For securing interior doors of a residence, where there is typically no need for the lock to withstand large forces, embodiments can utilize very small solenoids. Furthermore, depending on the application, the lock may either be engaged or disengaged when the solenoid is energized. In this way, power can be further conserved. In the particular embodiment shown in FIG. 2, battery 18 is contained with the door handle assembly 100. In certain other embodiments, mains AC is used as a power source.

As shown in the embodiments of FIG. 2 and FIG. 3, various components comprising the present invention may be housed within the door handle assembly 100. Such embodiments have the advantage of retaining a classic look and intuitive interface, as well as being convenient to retrofit into existing structures. Communications device 8 and controller 3 are both mounted to a substrate 2 having smaller dimensions than the circumference of a common doorknob. As shown in FIG. 3, certain embodiments may require substrate 2 to be drilled through to provide connection to the local input device 5 and visual indicator 12. As further shown in the embodiment of FIG. 2, battery 18 and door lock 16 are contained within the handle assembly 100. Door lock 16 may be located anywhere within assembly 100. Door lock 16 can provide considerable economy of space relative to existing locks relying on solely mechanical means. It should be apparent however, that any of the various components described may be alternatively located in either door 25 or wall 40. The housing materials used for the structural shell of handles 26 and 27 may be metallic, plastic, wood, or composites. Depending on the communications device used and actual location of the communications device, a window material transparent to RF or optical energy may be incorporated into the assembly.

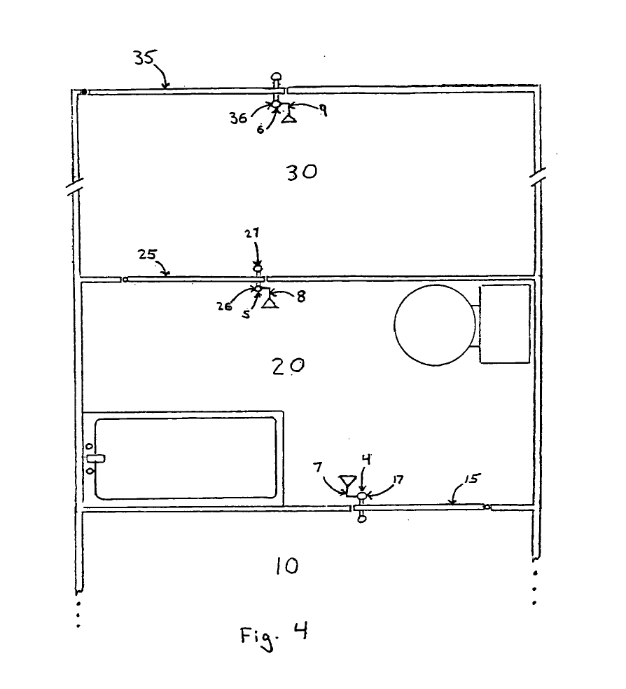

Certain embodiments of the present invention include synchronizing the actuation of a plurality of door locks such that the plurality is locked and unlocked in a coordinated fashion. In this way, a user entering through a first door or gated entryway into a room having more than one door or gated entry need only locally actuate the lock of the first door to secure all doors into the room. For example, in an embodiment shown in FIG. 4, a system is created when communications device 8 is placed in communication with the communications device 7. In the particular embodiment of FIG. 4, the door handle assembly 100 of FIG. 2 is fitted to door 25 of FIG. 4 and the labels are therefore deliberately consistent between FIG. 2 and FIG. 4. Similarly, door 15 of FIG. 4 comprises a door handle assembly of the same type as assembly 100 of FIG. 2. The door lock securing door 25 is actuated via local input device 5, causing the coupled wireless transceiver 8 to transmit a “lock” instruction to remotely lock door 15. The transmitted instruction is received by second wireless transceiver 7 which then locks the door lock in door 15. Similarly, locally unlocking door 25 causes wireless transceiver 8 to transmit an “unlock” instruction to second wireless transceiver 7, remotely unlocking door 15. In another specific embodiment, local actuation of the door lock securing door 25 via local input device 5 causes a coupled communications device to transmit a signal through a wired connection between door 25 and door 15 to remotely actuate the lock in door 15. Thus, embodiments of the present invention may be operated to secure and/or unsecure a plurality of entryways in a coordinated fashion. A system so configured can be operated from a single input proximate to the entryway physically accessed by the user or occupant.

Certain embodiments of the present invention include a door lock that can be actuated (locked and unlocked) from various sources originating from either side of a door. In such embodiments, a microcontroller applies an algorithm to the various actuation commands received to dictate engagement and disengagement of the door lock. In particular embodiments the inputs to the algorithm include: 1) the “value” of the actuation command, which can be either “lock” or “unlock;” 2) the “address” or identity of the source sending the actuation command; and 3) the existing state of the door lock (“locked” or “unlocked”). In this manner, the source of a received command as well as the command itself is a factor in determining the actuation of the door lock.

In various embodiments, the microcontroller algorithm can be programmed to assign lock actuation privileges to certain addresses. In one embodiment addresses can be assigned to distinguish between local and remote sources. In other embodiments, a master address may be assigned administrator privileges. In a first specific embodiment, the microcontroller algorithm is programmed such that when the door lock is engaged by a local “lock” command before a remote “lock” command is received, the door lock can only be disengaged by an “unlock” command originating from the same side of the door as the local “lock” command. For example, referring to FIG. 2, when the door lock is locked from an initial unlocked state by a local “lock” command received from local input device 5, the door lock 16 can only be returned to an unlocked state by a local “unlock” command received from local input device 5 or a remote “unlock” command received from the room 20 side of door 25 (the first side of assembly 100). Under this condition, priority is assigned to the room 20 side of door 25 and subsequent remote “lock” commands originating from the room 30 side of door 25 received by communications device 8 do not prevent disengaging the door lock 16 from the room 20 side of door 25. This ensures that a user who physically accesses room 20 through door 25 and triggers local input device 5 is not prevented from exiting room 20 via door 25 by subsequent remote “lock” commands originating from room 30 (the second side of assembly 100).

In another embodiment, the microcontroller algorithm is programmed such that when the door lock is engaged by a remote “lock” command (received prior to a local “lock” command), the door lock does not disengage until an “unlock” command is received from each side of the door from which a remote “lock” command was received. The microcontroller keeps in memory all remote addresses which have issued a “lock” command since the door lock was engaged by the first received remote “lock” command. Only when the same remote addresses have issued an “unlock” command does the controller finally disengage the door lock. For example, referring to FIG. 2, when the door lock 16 is locked from an initial unlocked state by a remote “lock” command received from the room 30 side of door 25 and a subsequent “lock” command (local or remote) is received from the room 20 side of door 25, door lock 16 can only be returned to an unlocked state by an “unlock” command received from both the room 20 side and the room 30 side of door 25 (door handle assembly 100). Thus, until an “unlock” command is received from each side of the door, the door lock remains engaged. In this embodiment, the present invention utilizes a single door lock to provide door 25 with two-way locking capability so that both room 20 and room 30 have greater privacy. Thus, again referring to FIG. 4, when an occupant in room 10 enters room 20 via door 15 and locally locks the door lock of door 15 with local input device 4, a command to remotely lock door 25 is sent from wireless transceiver 7 to wireless transceiver 8. When an occupant subsequently enters room 30 via door 35 and locally locks the door lock of door 35 with local input device 6, a command to remotely lock door 25 is sent from wireless transceiver 9 to wireless transceiver 8. The door handle assembly of door 25 is therefore instructed to lock from both the room 20 side and from the room 30 side. Under such a condition, the occupant of room 20 cannot enter room 30 and the occupant of room 30 cannot enter room 20 until an “unlock” command is received from both the room 30 and room 20 side of door 25. Thus, a two-way lock controls door 25. Because of the ability to remotely lock door 25, no means to locally lock door 25 need be provided on door handle 27. Similarly, door 15 need only have a local input device 4 on handle 17 for the purposes of locally engaging the door lock of door 15. When the occupant of room 20 locally disengages the door lock of door 15, for example, by turning handle 17, wireless transceiver 7 sends a command to transceiver 8 to remotely unlock door 25. At this point, occupant of room 30 can locally disengage the door lock of door 25, for example by turning handle 27, to enter room 20. Once in room 20, local input device 6 locally engages the door lock of door 25 and wireless transceiver 8 sends an instruction or command to transceiver 7 to remotely lock door 15.

In yet another embodiment, the microcontroller algorithm gives priority to the side of the door that issued the “lock” command responsible for engaging the door lock. In this embodiment, the present invention acts as a variable one-way lock wherein the lock control depends on the relative timing between “lock” commands originating from adjacent rooms.

Although the present invention has been described in language specific to structural features and/or methodological acts, it is to be understood that the invention defined in the appended claims is not necessarily limited to the specific features or acts described. Rather, the specific features and acts are disclosed as particularly graceful implementations of the claimed invention in an effort to illustrate rather than limit the present invention.

I claim:

1. An apparatus comprising:
a door lock;
a local input device coupled to the door lock to actuate the door lock; and
a wireless transceiver, to transmit information when the local input device locally actuates the lock.

2. The apparatus of claim 1, wherein the local input device comprises a pressure sensitive switch.

3. The apparatus of claim 1, wherein the information transmitted by the wireless transceiver coordinates the actuation of a second door lock.

4. The apparatus of claim 1, wherein the door lock and the wireless transceiver are contained within a door handle assembly.

5. The apparatus of claim 1, further comprising a battery.

6. The apparatus of claim 5, wherein the lock, the wireless transceiver, and the battery are contained within the door handle assembly.

7. The apparatus of claim 1, further comprising a visual indicator to display whether the door lock has been engaged or disengaged from either side of a door.

8. (canceled)

9. The apparatus of claim 1, wherein the wireless transceiver complies with the IEEE 802.15.4 communication standard.

10. The apparatus of claim 1, wherein the lock comprises a solenoid.

11. An apparatus comprising:
a door handle assembly having a first side and a second side; and a door lock remotely engagable from both the first side and second side, wherein the door lock, when remotely engaged from the first side of the door handle assembly, cannot be locally or remotely disengaged from the second side of the door handle assembly.

12. The apparatus of claim 11, wherein the door lock, when locally engaged from the first side of the door handle assembly, cannot be locally or remotely engaged from the second side until the door look is disengaged from the first side of the door handle assembly.

13. The apparatus of claim 11, wherein the door lock is locally engagable from only the first side of the door handle assembly.

14. The apparatus of claim 11, wherein local actuation of the door lock causes a wireless transceiver to transmit information.

15. The apparatus of claim 14, wherein the information contains an instruction to remotely actuate a second door lock in a coordinated manner.

16. The apparatus of claim 11, further comprising a visual indicator to display whether the door lock is locked from the first side or the second side of the door handle assembly.

17. An apparatus comprising:
a first lock coupled to a first wireless transceiver; and
a second lock coupled to a second wireless transceiver, the second wireless transceiver to transmit information by to the first wireless transceiver to coordinate actuation of the first lock with actuation of the second lock.

18. The apparatus of claim 17, wherein the second wireless transceiver transmits information when the second lock is locally actuated.

19. The apparatus of claim 17, wherein the first lock is contained in a first door handle assembly and the second lock is contained in a second door handle assembly.

20. The apparatus of claim 19, wherein the first and second door handle assemblies each further comprise a battery.

21. The apparatus of claim 1, further comprising a microcontroller to actuate the door lock upon the wireless transceiver receiving information coordinating the door lock actuation with a second door lock.
